(19) United States
(12) Patent Application Publication
(10) Pub. No.: US 2009/0073189 A1
(43) Pub. Date: Mar. 19, 2009

(54) SYSTEM AND METHOD FOR GENERATING VISUAL REPRESENTATIONS OF GRAPHICAL DATA AND DIGITAL DOCUMENT PROCESSING

(75) Inventors: Stephen NELSON, Glasgow (GB); Majid Anwar, Glasgow (GB)

Correspondence Address: DRINKER BIDDLE & REATH (DC), 1500 K STREET, N.W., SUITE 1100, WASHINGTON, DC, 20005-1209, US

(73) Assignee: Picsel (Research) Ltd., Glasgow (GB)

(21) Appl. No.: 12/211,292

(22) Filed: Sep. 16, 2008

(30) Foreign Application Priority Data
Sep. 17, 2007 (EP) 07270052
Sep. 17, 2007 (EP) 07270053

(51) Int. Cl. G09G 5/00

(52) U.S. Cl. 345/629

(57) ABSTRACT

A method, and associated systems and computer programs, for generating a visual display of graphical data comprises retrieving and displaying an initial approximate visual representation of the graphical data, progressively retrieving and displaying the graphical data, the graphical data being processed from source data representing a plurality of graphical elements, for full quality on-screen rendering. While the graphical data is being retrieved and/or the source data is being processed for full quality on-screen rendering, the display is progressively updated by blending the approximate representation with elements of the graphical data that have been retrieved for full quality on-screen rendering. The blending presents the approximate representation as a partially transparent overlay on top of the retrieved elements of graphical data.

This application claims benefit from European Patent Application Nos. EP07270052 and EP07270053, both filed on Sep. 17, 2007, the entire contents of each being incorporated herein by reference.

### BACKGROUND OF THE INVENTION

1. Field of the Invention

The invention relates to data processing methods and systems. More particularly, the invention relates to methods and systems for processing graphical data and digital documents, and to devices incorporating such methods and systems, in order to generate visual displays of source data and documents, such as those provided via streaming media.

2. Description of the Related Art

As understood by one skilled in the art and as used herein, the terms “graphical data”, “graphical object” and “digital document” pertain to a digital representation of any type of data processed by a data processing system which is intended, ultimately, to be output in some form, in whole or in part, to a human user, typically by being displayed or reproduced visually (e.g. by means of a visual display unit or printer), or by text-to-speech conversion, etc. Such data, objects and documents may include any features capable of representation, including but not limited to the following: text; graphical images; animated graphical images; full motion video images; interactive icons, buttons, menus or hyperlinks. A digital document may also include non-visual elements such as audio (sound) elements. A digital document generally includes or consists of graphical data and/or at least one graphical object.

Data processing systems, such as personal computer systems, PDAs etc., are typically required to process “digital documents”, which may originate from any one of a number of local or remote sources and which may exist in any one of a wide variety of data formats (“file formats”). In order to generate an output version of the document, whether as a visual display or printed copy, for example, it is generally necessary for the computer system to interpret the original data file and to generate an output compatible with the relevant output device (e.g., a monitor or other visual display device, or printer).

WO01/80178 describes digital document processing systems and methods wherein, when redrawing a visual display of graphical data so that a current display is replaced by an updated display, the current display is initially replaced with a first approximate representation of the updated display while the final updated display is being generated off-screen, and then the approximate representation is replaced with the final updated display. This provides the user with an indication of the content that is to be displayed while the final display is being processed for on-screen rendering. The delay in rendering the final display can be quite significant when the source data is very complex and/or where data is being streamed, for example, from a server to a thin client over a network connection. Also, the methods described in WO01/80178 include the use of successively improving approximations of the final display being displayed while the final display is being generated.

Depending upon the format of the source data and the manner in which it is processed and rendered, the initial approximation of the final display may be completely or partially obscured by elements of the final display content before processing of the final display content is complete. This is particularly so where the source data is processed and rendered as an ordered stack of graphical objects.

### BRIEF DESCRIPTION OF THE DRAWINGS

Embodiments of the invention will now be described, by way of example only, with reference to the accompanying drawings in which:

FIG. 1 is a schematic representation of an example of a visual display of graphical data comprising a plurality of graphical objects;

FIGS. 2A-2D illustrate an example of the manner in which the display of FIG. 1 is progressively updated as its component objects are decoded/retrieved;

FIG. 3 illustrates an example of the manner in which an approximate representation of the display would be employed in the scenario of FIGS. 1 and 2 in accordance with a conventional method;

FIGS. 4A-4D illustrate an example of the manner in which an approximate representation of the display would be employed in the scenario of FIGS. 1 and 2 in accordance with an embodiment of the present invention;

FIGS. 5A-5D illustrate an example of the manner in which a display of an image comprising a plurality of graphical objects would be progressively updated using a conventional method;

FIGS. 6A-6D provide a comparative illustration of an example of how the image of FIG. 5 would be progressively updated using a method according to an embodiment of the present invention;

FIGS. 7A and 7B are block diagrams illustrating examples of a server and client arrangement capable of performing a method according to an embodiment of the present invention.

### DETAILED DESCRIPTION OF THE EMBODIMENTS

It is generally an object of the present invention to provide methods, systems and computer program products for processing graphical data, graphical objects and digital documents, which obviate or mitigate the aforesaid disadvantages of known methods and systems.

The term “graphical data” is used herein to refer generally to whatever information is to be displayed visually. The term “source data” as used herein generally refers to data that encodes the graphical data in any suitable predetermined format and which must be processed in order to enable the graphical data to be displayed visually. The term “graphical” generally encompasses any kind of information that can be represented in a visual display.

It will be understood that, while it is generally preferable that an initial approximate visual representation of the graphical data can be the first thing to be displayed in accordance with the embodiments of the present invention described herein, it is not strictly necessary that this be the case. For example, one or more of the graphical elements may be displayed at full quality prior to an initial approximate representation.

As will also be understood from the description herein, the embodiments of the present invention are particularly applicable to the display of streaming media, such as media that is consumed (e.g., read, viewed etc.) while it is being delivered across a network connection.

Referring now to the drawings, FIG. 1 shows a simple example of a display of graphical data for the purposes of illustrating embodiments of the present invention. The display comprises a background 10 (i.e., whatever would be displayed in the absence of graphical data represented by the source data of interest), and graphical objects 12, 14 and 16. The objects may be represented by source data in any of a variety of formats. The objects are decoded and rendered for display by any suitably programmed data processing system.

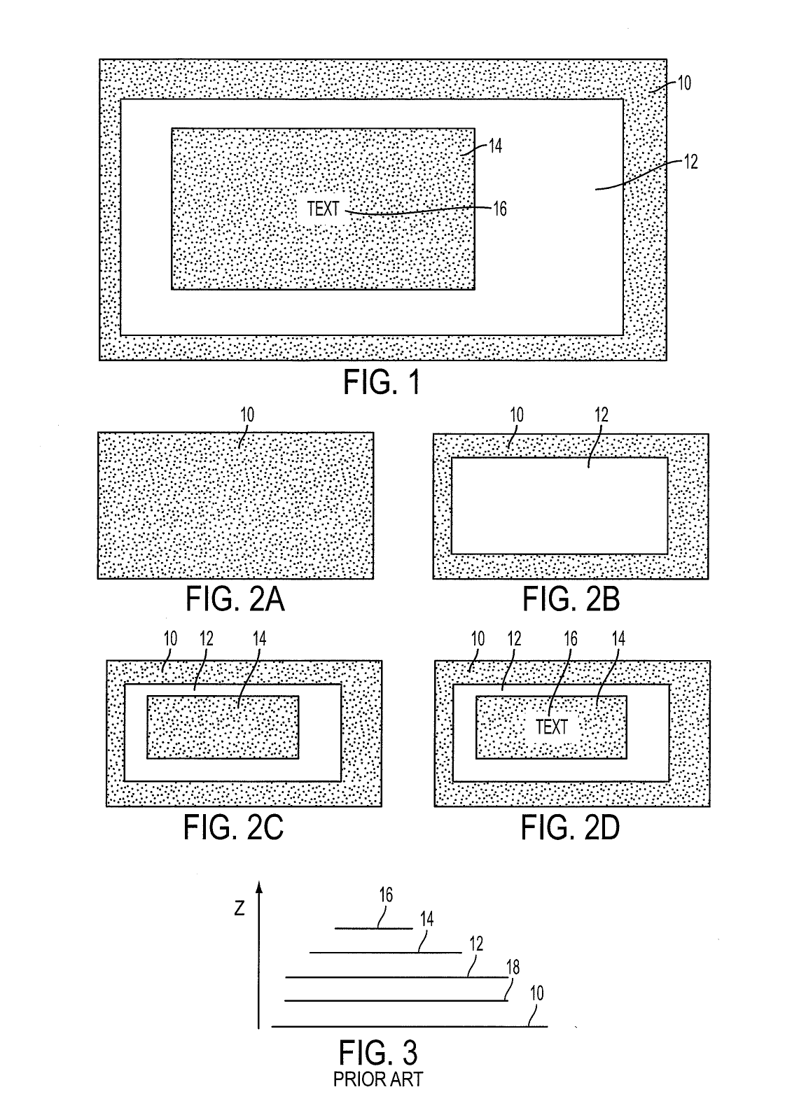

Certain embodiments of the present invention are particularly concerned with data formats in which objects are encoded individually as an ordered “stack” of objects and are decoded and rendered in stack order, so that the final display is rendered progressively, with multiple screen updates, as the objects 12-16 are decoded, as illustrated in FIGS. 2A-2D. FIG. 3 is a graph representing the background 10 and objects 12-16 of FIGS. 1 and 2 stacked in “z-order”, together with an additional object 18 which is an approximate representation, such as a bitmap (e.g., a low-resolution bitmap), of the combination of the objects 12-16, as discussed above. If the approximate representation 18 is retrieved and displayed first, then with conventional rendering techniques, it will be obscured from view (i.e., overwritten) when the next object 12 is rendered.

The embodiments of present invention provide a system and method whereby an approximate representation of this type will not be obscured during stack order rendering of graphical objects. That is, a method according to an embodiment of the present invention involves retrieving and displaying an initial approximate visual representation of the graphical data as before, and progressively retrieving and displaying the graphical data, which is processed from source data representing a plurality of graphical elements (objects), for full quality on-screen rendering. In order to prevent the initial approximate representation from being obscured by subsequent objects while the graphical data is being retrieved and/or the source data is being processed for full quality on-screen rendering, the display is progressively updated by blending the approximate representation with elements of the graphical data that have been retrieved for full quality on-screen rendering.

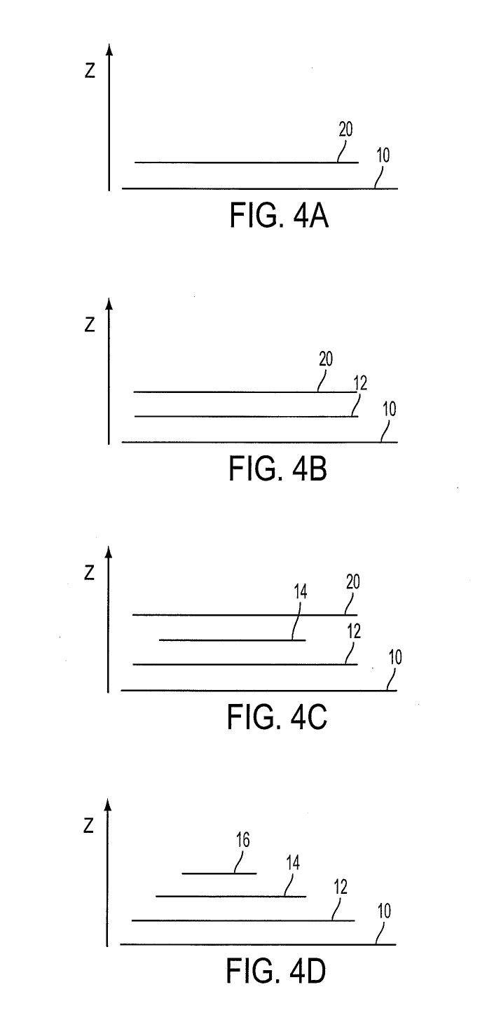

This blending has the effect of presenting the approximate representation as a partially transparent overlay on top of the retrieved elements of graphical data, as illustrated in FIGS. 4A-4D, in which the approximate representation is designated by reference numeral 20 and the graphical objects are designated 12-16 as in FIGS. 1-3. As seen in FIGS. 4A-4C, the approximate representation 20 is rendered first (FIG. 4A). When the first graphical object 12 is rendered, it is blended with the approximate representation 20, so that the latter appears as a partially transparent overlay on top of the first object 12 (FIG. 4B). When the second graphical object 14 is retrieved, it is combined with the first object 12 in the usual manner and the combination is blended with the approximate representation (FIG. 4C). This may be repeated for any number of graphical objects. When the final object 16 is rendered, the approximate representation 20 may be removed (FIG. 4D) as discussed further below.

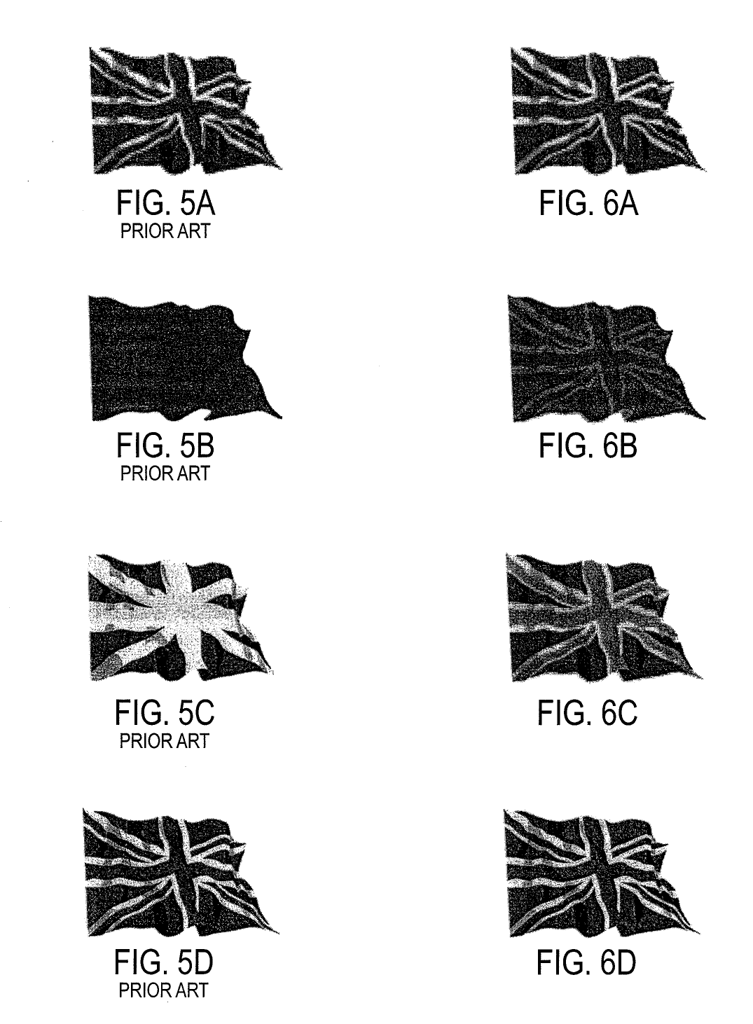

The visual effect achieved by a method according to an embodiment of the present method as shown in FIGS. 6A-6D can be compared with that of a conventional method such as that described in WO01/80178 as shown in FIGS. 5A-5D. In each case, the initial display A can be of a low resolution version of the final, full quality image D. In the conventional method, the first fully rendered object shown in FIG. 5B completely obscures the initial low resolution version shown in FIG. 5A. Successive objects are rendered on top of the first object shown in FIG. 5B in successive display updates shown in FIGS. 5C and 5D. Once the initial low resolution display has been obscured, the complete content of the image does not become visible again until the final version as shown in FIG. 5D.

By comparison, blending the successive objects with the initial version, which can be a low resolution version, as in FIGS. 6A-6D according to an embodiment of the present invention means that the complete content of the image is visible at all times, albeit at reduced resolution, until the final rendering at FIG. 6D. The effect of the blending process can be seen in the way that the lighter areas of the low resolution version shown in FIG. 6A are darkened by blending with the dark background object in FIG. 6B (seen on its own in FIG. 5B) and then lightened by blending with the next, lighter object in FIG. 6C. It should also be noted that the images shown in FIGS. 6A-6C need not be low resolution images, but rather, can be full resolution images.

The blending of the approximate representation and the retrieved elements of graphical data may be accomplished by combining pixel values of the approximate representation and corresponding pixel values of the retrieved elements according to a predetermined weighting factor. Pixel blending of this type is commonly referred to as “alpha blending”; that is, the combination of two colors allowing for transparency effects in computer graphics, the weighting factor being referred to as “alpha.” The value of alpha in the color code ranges from, for example, at or about 0.0 to at our about 1.0, where, conventionally, 0.0 represents a fully transparent color, and 1.0 represents a fully opaque color.

The value of the resulting color when color Value1 is drawn over a background of color Value0 is given by:

Value=Value0(1.0−alpha)+Value1(alpha)

The display may be progressively updated in multiple steps until all of the elements of the graphical data have been retrieved to provide a complete, full quality on-screen rendering of the source data. The approximate representation may be removed entirely when the final object has been rendered (FIG. 4D), or at any other selected point during the progressive rendering of the source data.

The weighting factor alpha may be progressively adjusted at each update step to reduce the weighting of the approximate representation, so that the approximate representation gradually fades from view as more of the full-quality objects are rendered. It will be understood that, in the context of “alpha blending,” the question of whether the approximate representation is regarded as being “on top” of the other elements is largely arbitrary and subjective, since the relevant pixel values are combined according to the applicable alpha value to obtain a single, pixel value. This terminology is used primarily to enable a more immediate understanding of the effect of the alpha blending process.

The display may be updated at predetermined intervals or at variable intervals as one or more graphical elements are retrieved. In certain embodiments, the approximate representation may be replaced by successively better quality approximate representations at selected display updates. The initial approximate representation, and any subsequent better quality approximate representations, may suitably comprise at least one of a text label, an icon and a bitmap (e.g., a reduced resolution bitmap) of the graphical data.

As noted previously, the method is particularly suited for use where the source data represents an ordered stack of graphical elements. Referring to the example of FIGS. 1 and 2, the approximate representation, which is item 20 in FIGS. 4A-4C (also shown in FIG. 6A), would typically be retrieved and rendered first. The first object 12 would then be retrieved and prepared for rendering in a conventional manner. Prior to rendering, however, the first object 12 would be blended with the approximate representation 20 according to the selected alpha, and the combination rendered (as shown in FIG. 6B). The second object 14 would then be retrieved and prepared for rendering, the combination of the first and second objects 12 and 14 being blended with the approximate representation 20 prior to rendering, as shown in FIG. 6B. This may be repeated for any arbitrary number of objects as shown, for example, in FIG. 6C. At each stage the approximate representation 20 is displayed as a partially transparent overlay on top of the objects that have been retrieved and rendered so far. When the final object 16 is retrieved, the combination of the objects 12-16 may be rendered to provide the final, full quality display, without the approximate representation 20, as shown in FIG. 6D.

The approximate representations utilized in the method may be obtained or derived in a number of ways. The source data may include the initial approximate representation, and any subsequent better quality approximate representations. That is, the approximate representations may be embedded in the source data when it is created or in a subsequent process. Alternatively, the initial approximate representation and any subsequent better quality approximate representations may be generated from the source data. For example, where the source data is streamed from a server to a client, the server may generate at least an initial approximate representation from the source data before it begins streaming the data to the client. Subsequent better quality approximate representations may be generated on the fly during streaming. Approximate representations generated in this way may be generated the first time the source data is accessed and stored for use whenever the data is accessed subsequently. Alternatively, the approximate representations could be generated and stored in advance of the data being accessed.

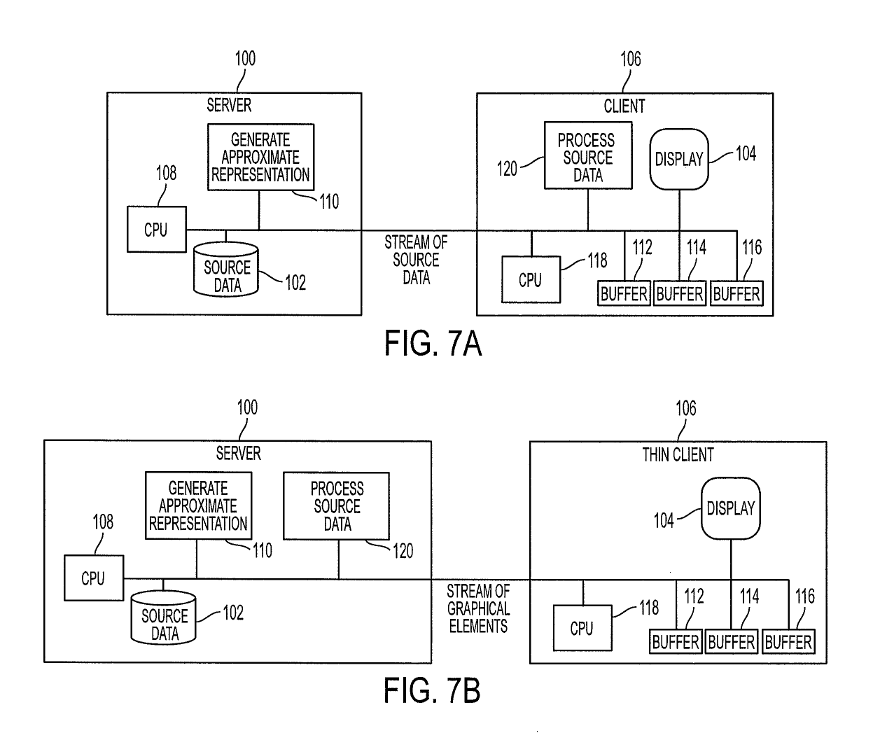

As noted, the method according to an embodiment of the present invention is particularly useful in client-server systems such as those shown in FIGS. 7A and 7B, and is especially for use with thin clients as shown in FIG. 7B. In these cases, the server 100 includes a storage 102 for storing source data, and the display 104 is at a client 106 connected to the server 100 via any suitable network connection. Generally, the source data will be processed by the server 100 under control of, for example, a CPU 108, and the graphical elements are transmitted from the server 100 to the client 106 as shown in FIG. 7B, but in some cases, the source data may be transmitted from the server 100 to the client and processed by the client 106 as shown in FIG. 7A.

Blending of the approximate representation and the graphical data may be accomplished by a variety of methods. For example, as shown in FIG. 7A, the approximate representation 110 may be generated at the server 100 under the control of the CPU 108 and transmitted to the client 106. At the client 106, the approximate representation may be stored in a first buffer 112, the retrieved graphical data stored in a second buffer 114, and the two blended and stored in a third buffer 116 under the control of a CPU 118. Alternatively, the retrieved approximate representation may be stored in a first buffer, the retrieved graphical data stored in a second buffer and the two blended and stored in the first or second buffer. In a further alternative, the approximate representation and the retrieved graphical data are blended directly into a first buffer. The specific manner in which these blending processes may be performed will be apparent to those skilled in the art, given the present disclosure of the invention, and will not be described in detail herein.

As discussed above, a method according to an embodiment of the present invention may be implemented in any suitable data processing system, including client-server systems, in which case the server 100 is typically adapted to store the source data and the client 106 includes the visual display 104. As shown in FIG. 7A, the server 100 may be adapted to transmit the source data to the client 106 and the client is 106 adapted to process the source data 120 to create the graphical elements as described herein under control of, for example, the CPU 118. Alternatively, as shown in FIG. 7B, the server 100 may be adapted to process the source data 120 under control of, for example, CPU 108, and to transmit the graphical elements to the client 106 as would typically be the case for a thin client 106.

In a client server scenario where the source data is decoded by the server and decoded graphical objects are streamed to a client, a series of approximate representations can be embedded in the data stream, interspersed between sequences of one or more of the graphical objects. For example, a first approximate representation may comprise a text label, such as a file name, a next approximate representation may comprise an icon and further approximate representations may comprise bitmaps (e.g., reduced resolution bitmaps), of progressively improving quality, of the graphical data.

The following Table 1 illustrates an example of such a data stream and the manner on which it is decoded, in which GO1 through G010 are the graphical objects and AR1 through AR3 are successive approximate representations.

TABLE 1

| Data Stream | Display |
|---|---|
| AR1 | AR1 |
| GO1 | GO1 blended with AR1 |
| GO2 | GO1 + GO2 blended with AR1 |
| GO3 | GO1 + GO2 + GO3 blended with AR1 |
| AR2 | GO1 + GO2 + GO3 blended with AR2 |
| GO4 | GO1 + GO2 + GO3 + GO4 blended with AR2 |
| GO5 | GO1 + GO2 + GO3 + GO4 + GO5 blended with AR2 |
| GO6 | GO1 + GO2 + GO3 + GO4 + GO5 + GO6 blended with |
| | AR2 |
| GO7 | GO1 + GO2 + GO3 + GO4 + GO5 + GO6 + GO7 blended |
| | with AR2 |
| AR3 | GO1 + GO2 + GO3 + GO4 + GO5 + GO6 + GO7 blended |
| | with AR3 |
| GO8 | GO1 + GO2 + GO3 + GO4 + GO5 + GO6 + GO7 + GO8 |
| | blended with AR3 |
| GO9 | GO1 + GO2 + GO3 + GO4 + GO5 + GO6 + GO7 + G09 |
| | blended with AR3 |
| GO10 | GO1 + GO2 + GO3 + GO4 + GO5 + GO6 + GO7 + G09 + |
| | GO10 |

It will be understood that the number of graphical objects, the number and nature of the approximate representations and the intervals at which the approximate representations are embedded in the data stream may vary in practice. The alpha factor used may be altered as previously described in any or all of the successive blending operations.

As can be further understood, the techniques according to the embodiments of the present invention described herein allow progressively meaningful information to be presented on the display while the data is being streamed to the client. The approximate representations may be obtained or derived in any of the ways described above.

The blending and rendering of the approximate representation(s) and graphical objects as described herein may be performed by any suitably programmed data processing system. Digital document processing systems incorporating a shape processor, as described for example in WO01/79984 and WO01/80183, are particularly well suited for this purpose.

A shape processor of this type generally processes graphical objects to be displayed (including, in this case, the approximate representation(s)) in terms of a rectangular boundary box, the actual “shape” of the object bounded by the boundary box, (i.e. the outline shape of the object), “fill” (the data content of the object) and “alpha” (the transparency of the object), performs scaling and clipping appropriate to the required view and output device, and expresses the object in terms appropriate to the output device (typically in terms of pixels by scan conversion or the like, for most types of display device or printer). The individual objects processed by the shape processor are combined in a composite output frame.

The examples described above with reference to FIGS. 1 to 4D assume that the final display content is assembled from an ordered stack of discrete, mutually-overlapping graphical objects. However, it is possible that in practice, at least some objects will overlap one another to at least some extent. It is also possible that the final display content will comprise a number of non-overlapping blocks of display content. Each such block may consist of a single graphical object or a group of graphical objects. Where the content is being streamed from a server to a client, an initial approximate representation of the complete display may be provided as described above and, subsequently, individual, non-overlapping content blocks successively combined with the initial approximation until the final display is complete.

In such a scenario, the content of each block may be delivered “complete” in the data stream (i.e., each block is itself a single “graphical element” that comprises the final display content of the corresponding area of the final display). In that case, it may not be necessary for individual blocks to be blended with the initial approximation as the final display is built up, but rather, each block may simply replace the corresponding area of the initial approximation. However, if the content of each block is built up progressively from a number of individual elements, it may still be desirable for the individual elements of the block to be blended with the initial approximation at least until the content of that block is complete.

The embodiments of the present invention described herein further encompass data processing systems programmed to implement the methods described herein. In this respect, a data processing system adapted to display the graphical data is programmed to blend the approximate representation(s) with the graphical elements (objects) as described. In a client-server scenario, this function is performed by the client. The server is programmed to incorporate the approximate representation(s) into the graphical data streamed from the client to the server. In certain embodiments, as described, the server is programmed to generate the approximate representation(s) from the source data.

The embodiments of the present invention described herein invention further encompass computer program products adapted to perform all or part of the methods described when executed. Such program products include applications adapted to generate and incorporate the approximate representation(s) into the source data, to generate the approximate representation(s) from the source data and to blend the approximate representation(s) with the graphical elements for display in the manner described.

Improvements and modifications may be incorporated without departing from the scope of the invention as defined in the appended claims. Although only a few exemplary embodiments of the present invention have been described in detail above, those skilled in the art will readily appreciate that many modifications are possible in the exemplary embodiments without materially departing from the novel teachings and advantages of this invention. For example, the order and functionality of the steps shown in the processes may be modified in some respects without departing from the spirit of the present invention. Accordingly, all such modifications are intended to be included within the scope of this invention.

What is claimed is:

1. A method of generating a visual display of graphical data, said graphical data comprising a plurality of graphical elements, and the visual display of said graphical data being derived from source data that encodes said graphical elements in a predetermined data format and which is processed to enable full quality on-screen rendering of said graphical elements, the method comprising:
retrieving and displaying an initial approximate visual representation of the graphical data;
progressively retrieving and displaying the elements of the graphical data at full quality; and
while at least one of the graphical data is being retrieved and the source data is being processed for full quality on-screen rendering, progressively updating the display by blending the approximate representation with elements of the graphical data that have been retrieved for full quality display, wherein blending presents the approximate representation as a partially transparent overlay on top of the retrieved elements of graphical data.

2. A method according to claim 1, wherein the approximate representation and the retrieved elements of graphical data are blended by combining pixel values of the approximate representation and corresponding pixel values of the retrieved elements according to a predetermined weighting factor.

3. A method according to claim 1, wherein the display is progressively updated in multiple steps until all of the elements of the graphical data have been retrieved to provide a complete, full quality on-screen rendering of the graphical data.

4. A method according to claim 2, wherein the display is progressively updated in multiple steps until all of the elements of the graphical data have been retrieved to provide a complete, full quality on-screen rendering of the graphical data, and wherein the weighting factor is progressively adjusted to reduce the weighting of the approximate representation.

5. A method according to claim 3, wherein the display is updated at predetermined intervals.

6. A method according to claim 3, wherein the display is updated at variable intervals as one or more graphical elements are retrieved.

7. A method according to claim 1, wherein the approximate representation is replaced by successively better quality approximate representations at selected display updates.

8. A method according to claim 1, wherein the initial approximate representation and any subsequent better quality approximate representations comprise at least one of a text label, an icon and a reduced resolution bitmap of the graphical data.

9. A method according to claim 1, wherein the source data represents an ordered stack of graphical elements.

10. A method according to claim 1, wherein the source data includes the initial approximate representation and any subsequent better quality approximate representations.

11. A method according to claim 1, wherein the initial approximate representation and any subsequent better quality approximate representations are generated from the source data.

12. A method according to claim 1, wherein the source data is stored in a server and the display is at a client connected to the server.

13. A method according to claim 12, wherein the source data is processed by the server and the graphical elements are transmitted from the server to the client.

14. A method according to claim 13, wherein the source data is processed by the server to generate a stream of graphical elements that are to be displayed and said stream is transmitted from the server to the client.

15. A method according to claim 12, wherein the source data is transmitted from the server to the client and processed by the client.

16. A method according to claim 14, wherein at least one approximate visual representation of the graphical data is included in the stream of graphical elements.

17. A system of generating a visual display of graphical data, said graphical data comprising a plurality of graphical elements, and the visual display of said graphical data being derived from source data that encodes said graphical elements in a predetermined data format and which is processed to enable full quality on-screen rendering of said graphical elements, the system comprising:
a controller that controls the following operations:
retrieving and displaying on the visual display an initial approximate visual representation of the graphical data;
progressively retrieving and displaying on the visual display the elements of the graphical data at full quality; and
while at least one of the graphical data is being retrieved and the source data is being processed for full quality on-screen rendering, progressively updating the visual display by blending the approximate representation with elements of the graphical data that have been retrieved for full quality display, wherein blending presents the approximate representation as a partially transparent overlay on top of the retrieved elements of graphical data.

18. A system according to claim 17, comprising a client-server system wherein the server stores the source data and the client includes the visual display.

19. A system according to claim 18, wherein the server processes the source data and operates to transmit the graphical elements to the client.

20. A system according to claim 19, wherein the graphical elements transmitted from the server to the client includes at least one approximate visual representation of the graphical data.

21. A system according to claim 18, wherein the server operates to transmit the source data to the client and the client processes the source data.

22. A computer program embodied on a recordable medium for controlling a computer to perform the method according to claim 1.
